(19) United States
(12) Patent Application Publication
(10) Pub. No.: US 2023/0027307 A1
(43) Pub. Date: Jan. 26, 2023

(54) HYPERVISOR-ASSISTED TRANSIENT CACHE FOR VIRTUAL MACHINES

(71) Applicant: VMWARE, INC., Palo Alto, CA (US)

(72) Inventors: Sachin Shinde, Pune (IN); Zubraj Singha, Bangalore (IN); Goresh Musalay, Bangalore (IN); Tanay Ganguly, Bangalore (IN); Kashish Bhatia, Bangalore (IN)

(21) Appl. No.: 17/496,781

(22) Filed: Oct. 8, 2021

(30) Foreign Application Priority Data
Jul. 20, 2021 (IN) 202141032577

(51) Int. Cl. G06F 9/455

(52) U.S. Cl. CPC G06F 9/45558; G06F 2009/45583

(57) ABSTRACT

An example method of providing a transient cache in system memory of a host for swap space on storage accessible by the host, the method including: identifying, by transient cache drivers executing in virtual machines (VMs) supported by a hypervisor executing on the host, unused space in code pages of a plurality of processes executing in the VMs; sending, from the transient cache drivers to a transient cache manager of the hypervisor, unused space metadata describing the unused space; creating, by the transient cache manager based on the unused space metadata, the transient cache in the system memory by aggregating the unused space; and providing, to a first transient cache driver of the transient cache drivers executing in a first VM of the VMs, information for accessing the transient cache.

### RELATED APPLICATION

Benefit is claimed under 35 U.S.C. 119(a)-(d) to Foreign Application Serial No. 202141032577 filed in India entitled “HYPERVISOR-ASSISTED TRANSIENT CACHE FOR VIRTUAL MACHINES”, on Jul. 20, 2021, by VMware, Inc., which is herein incorporated in its entirety by reference for all purposes.

### BACKGROUND

Computer virtualization is a technique that involves encapsulating a physical computing machine platform into virtual machine(s) executing under control of virtualization software on a hardware computing platform or “host.” A virtual machine (VM) provides virtual hardware abstractions for processor, memory, storage, and the like to a guest operating system. The virtualization software, also referred to as a “hypervisor,” incudes one or more virtual machine monitors (VMMs) to provide execution environment(s) for the virtual machine(s). As physical hosts have grown larger, with greater processor core counts and terabyte memory sizes, virtualization has become key to the economic utilization of available hardware.

Guest operating systems executing in VMs include memory managers that can swap memory pages between memory and swap areas on virtual disks. When a guest attempts to access memory pages that have been swapped to a virtual disk, the guest OS handles a page fault and performs a disk input/output (IO) operation to fetch the requested data. Such an operation is dependent on the storage stack of the hypervisor and adds read overhead on the storage disk(s) that store the virtual disk being accessed. This can reduce the performance of the VM in addition to the hypervisor.

### SUMMARY

One or more embodiments relate to a method of providing a transient cache in system memory of a host for swap space on storage accessible by the host, the method comprising: identifying, by transient cache drivers executing in virtual machines (VMs) supported by a hypervisor executing on the host, unused space in code pages of a plurality of processes executing in the VMs; sending, from the transient cache drivers to a transient cache manager of the hypervisor, unused space metadata describing the unused space; creating, by the transient cache manager based on the unused space metadata, the transient cache in the system memory by aggregating the unused space; and providing, to a first transient cache driver of the transient cache drivers executing in a first VM of the VMs, information for accessing the transient cache.

Further embodiments include a non-transitory computer-readable storage medium comprising instructions that cause a computer system to carry out the above method, as well as a computer system configured to carry out the above method. Though certain aspects are described with respect to VMs, they may be similarly applicable to other suitable physical and/or virtual computing instances.

### BRIEF DESCRIPTION OF THE DRAWINGS

FIG. 1 is a block diagram depicting a virtualized computing system according to an embodiment.

FIG. 2 is a block diagram depicting process metadata maintained by a guest operating system according to an embodiment.

FIG. 3 is a flow diagram depicting a method of identifying unused space in code pages for use as a transient cache according to embodiments.

FIG. 4 is a flow diagram depicting a method of creating and managing a transient cache in a hypervisor according to embodiments.

FIG. 5 is a flow diagram depicting a method of using a transient cache in a virtual machine according to embodiments.

FIG. 6 is a block diagram depicting operation of a transient cache manager and a transient cache driver according to embodiments.

FIG. 7 is a flow diagram depicting a method of updating a transient cache as new virtual machines become active in according to embodiments.

FIG. 8 is a flow diagram depicting a method of updating a transient cache in case of process or VM termination according to embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

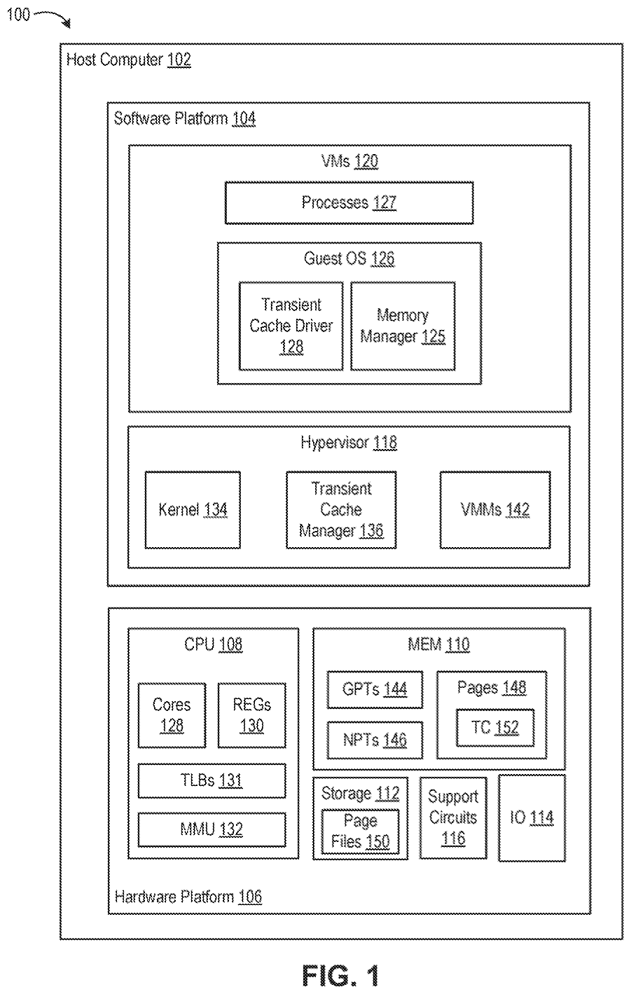

FIG. 1 is a block diagram depicting a virtualized computing system 100 according to an embodiment. Virtualized computing system 100 includes a host computer 102 having a software platform 104 executing on a hardware platform 106. Hardware platform 106 may include conventional components of a computing device, such as a central processing unit (CPU) 108, system memory (MEM) 110, a storage system (storage) 112, input/output devices (TO) 114, and various support circuits 116. CPU 108 is configured to execute instructions, for example, executable instructions that perform one or more operations described herein and may be stored in system memory 110 and storage system 112. System memory 110 is a device allowing information, such as executable instructions, virtual disks, configurations, and other data, to be stored and retrieved. System memory 110 may include, for example, one or more random access memory (RAM) modules. Storage system 112 includes local storage devices (e.g., one or more hard disks, flash memory modules, solid state disks, and optical disks) and/or a storage interface that enables host computer 102 to communicate with one or more network data storage systems. Examples of a storage interface are a host bus adapter (HBA) that couples host computer 102 to one or more storage arrays, such as a storage area network (SAN) or a network-attached storage (NAS), as well as other network data storage systems. Storage 112 in multiple hosts 102 can be aggregated and provisioned as part, of shared storage accessible through a physical network (not shown). Input/output devices 114 include conventional interfaces known in the art, such as one or more network interfaces. Support circuits 116 include conventional cache, power supplies, clock circuits, data registers, and the like.

CPU 108 includes one or more cores 128, various registers 130, and a memory management unit (MMU) 132. Each core 128 is a microprocessor, such as an x86 microprocessor. Registers 130 include program execution registers for use by code executing on cores 128 and system registers for use by code to configure CPU 108. MMU 132 supports paging of system memory 110. Paging provides a “virtual memory” environment where a virtual address space is divided into pages 148, which are either stored in system memory 110 or in storage 112. Pages 148 are individually addressable units of memory. Each page 148 (also referred to herein as a “memory page”) includes a plurality of separately addressable data words, each of which in turn includes one or more bytes. Pages 148 are identified by addresses referred to as “page numbers.” CPU 108 can support multiple page sizes. For example, modern x86 CPUs can support 4 kilobyte (KB), 2 megabyte (MB), and 1 gigabyte (GB) page sizes. Other CPUs may support other page sizes. Each page 148 can be identified by multiple page numbers across different levels of the translation hierarchy (e.g., guest virtual page number, guest physical page number, machine page number).

MMU 132 translates virtual addresses in the guest virtual address space (also referred to as guest virtual page numbers) into physical addresses of system memory 110 (also referred to as machine page numbers). MMU 132 also determines access rights for each address translation. An executive (e.g., operating system, hypervisor, etc.) exposes page tables to CPU 108 for use by MMU 132 to perform address translations. Page tables can be exposed to CPU 108 by writing pointer(s) to control registers in registers 130 and/or control structures accessible by MMU 132. Page tables can include different types of paging structures depending on the number of levels in the hierarchy. A paging structure includes entries, each of which specifies an access policy and a reference to another paging structure or to a memory page. Translation lookaside buffer (TLB) 131 to caches address translations for MMU 132. MMU 132 obtains translations from TLB 131 if valid and present. Otherwise, MMU 132 “walks” page tables to obtain address translations. CPU 108 can include an instance of MMU 132 and TLB 131 for each core 128.

CPU 108 can include hardware-assisted virtualization features, such as support for hardware virtualization of MMU 132. For example, modern x86 processors commercially available from Intel Corporation include support for MMU virtualization using extended page tables (EPTs). Likewise, modern x86 processors from Advanced Micro Devices, Inc. include support for MMU virtualization using Rapid Virtualization Indexing (RVI). Other processor platforms may support similar MMU virtualization. In general, CPU 108 can implement hardware MMU virtualization using nested page tables (NPTs) 146. In a virtualized computing system, a guest OS in a VM maintains page tables (referred to as guest page tables (GPTs) 144) for translating virtual addresses to physical addresses for a VM memory provided by the hypervisor (referred to as guest physical addresses). The hypervisor maintains NPTs 146 that translate guest physical addresses to physical addresses for system memory 110 (referred to as machine addresses). Each of the guest OS and the hypervisor exposes GPTs 144 and the NPTs 146, respectively, to the CPU 108. MMU 132 translates virtual addresses to machine addresses by walking GPTs 144 to obtain guest physical addresses, which are used to walk NPTs 146 to obtain machine addresses.

Software platform 104 includes a virtualization layer that abstracts processor, memory, storage, and networking resources of hardware platform 106 into one or more virtual machines (“VMs”) that run concurrently on host computer 102. The VMs run on top of the virtualization layer, referred to herein as a hypervisor, which enables sharing of the hardware resources by the VMs. In the example shown, software platform 104 includes a hypervisor 118 that supports VMs 120. One example of hypervisor 118 that may be used in an embodiment described herein is a VMware ESXi™ hypervisor provided as part of the VMware vSphere® solution made commercially available from VMware, Inc. of Palo Alto, Calif. (although it should be recognized that any other virtualization technologies, including Xen® and Microsoft Hyper-V® virtualization technologies may be utilized consistent with the teachings herein). Hypervisor 118 includes a kernel 134, transient cache manager 136, and virtual machine monitors (VMMs) 142.

Each VM 120 includes guest software that runs on the virtualized resources supported by hardware platform 106. In the example shown, the guest software of VM 120 includes a guest OS 126 and processes 127. Guest OS 126 can be any commodity operating system known in the art (e.g., Linux®, Windows®, etc.). Processes 127 can be applications, drivers, services, and the like that are part of guest OS 126 or otherwise managed by guest OS 126. Guest OS 126 includes a transient cache driver 128 and a memory manager 125. Memory manager 125 maintains GPTs 144 for each of the processes 127 (e.g., each process has its own virtual address space mapped to guest physical memory).

Kernel 134 provides operating system functionality (e.g., process creation and control, file system, process threads, etc.), as well as CPU scheduling and memory scheduling across guest software in VMs 120, VMMs 142, and transient cache manager 136. VMMs 142 implement the virtual system support needed to coordinate operations between hypervisor 118 and VMs 120. Each VMM 142 manages a corresponding virtual hardware platform that includes emulated hardware, such as virtual CPUs (vCPUs) and guest physical memory (also referred to as VM memory). Each virtual hardware platform supports the installation of guest software in a corresponding VM 120. Each VMM 142 further maintains page tables (e.g., NPTs 146) on behalf of its VM(s), which are exposed to CPU 108.

A guest OS 126 can maintain a page file 150 on a virtual disk stored in storage 112. Guest OS 126 can swap data between memory 110 and storage 112. As noted above, this involves disk operations, which can reduce performance during swapping operations. Techniques described herein create an extended physical memory for a selected VM 120 that can be used as a swap cache between memory 110 and page file 150 in storage 112 (referred to as a “transient cache”). As described further herein, transient cache manager 136 cooperates with transient cache driver 128 in each VM 120 to collate unused portions of pages 148 in use by some processes 127. Transient cache manager 136 creates a transient cache (TC) 152 by aggregating the unused memory. A user can enable one VM 120 to use TC 152. Transient cache manager 136 passes information about TC 152 to transient cache driver 128 in the selected VM 120. Transient cache driver 128 hooks into memory manager 125 and monitors for PAGE_IN and PAGE_OUT swap operations. If possible, transient cache driver 128 can page in/out from TC 152, which avoids use of page file 150 and increases performance. Further details of these techniques are described below.

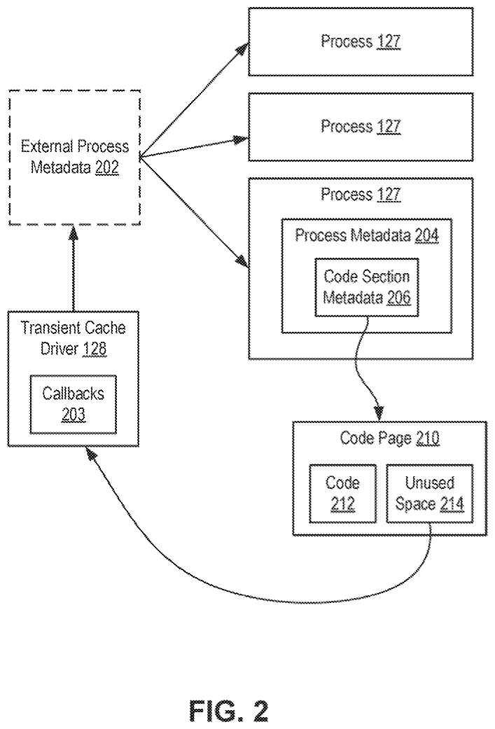

FIG. 2 is a block diagram depicting process metadata maintained by a guest operating system according to an embodiment. Transient cache driver 128 is configured to execute early during boot of guest OS 126 (e.g., as the first driver to be loaded by guest OS 126). Transient cache driver 128 registers callbacks 203 with guest OS 126 to be notified upon execution of subsequent processes. In embodiments, transient cache driver 128 monitors for long-running processes, such as those that execute for substantially the lifetime of the guest OS 126 and/or have their pages pinned in memory (e.g., not allowed to be swapped to disk). Such processes include drivers, system services, and the like.

Having identified a process of interest, transient cache driver 128 obtains the location in memory for the process image. Guest OS 126 maintains external process metadata 202 for processes 127. External process metadata 202 includes various data structures that include information related to processes 127 and separate from processes 127. For example, the Windows® operating system includes various process-related data structures, such as EPROCESS, virtual address descriptors (VADs), process environment block (PEB), and the like. Transient cache driver 128 can read external process metadata 202 to discover the base address of the process image given process identification information obtained from callbacks 203. Alternatively, transient cache driver 128 can obtain the process image base address as input to callbacks 203.

Each process 127 loaded into memory 110 includes process metadata 204. For example, in the Windows® operating system, each loaded process includes a portable executable (PE) data structure. Process metadata 204 includes information related to various sections of the process executable, including the code section, data section, and the like. In particular, process metadata 204 includes code section metadata 206 that includes information related to the code section of the process executable. Code section metadata 206 can include, for example, a page number for locating the start of the executable code for the process and the size of the code. Guest OS 126 can be configured such that process code sections are page aligned, that is, the code for a process starts at the beginning of a page. If the executable code of a process does not evenly fill a multiple of the page size (e.g., a multiple of 4 KB), then there is some portion of a page having both executable code and unused space. Accordingly, transient cache driver 128 can read code section metadata 206 to identify a code page 210 that includes both code 212 for process 127 and unused space 214 (assuming the process executable code is not an exact multiple of the page size).

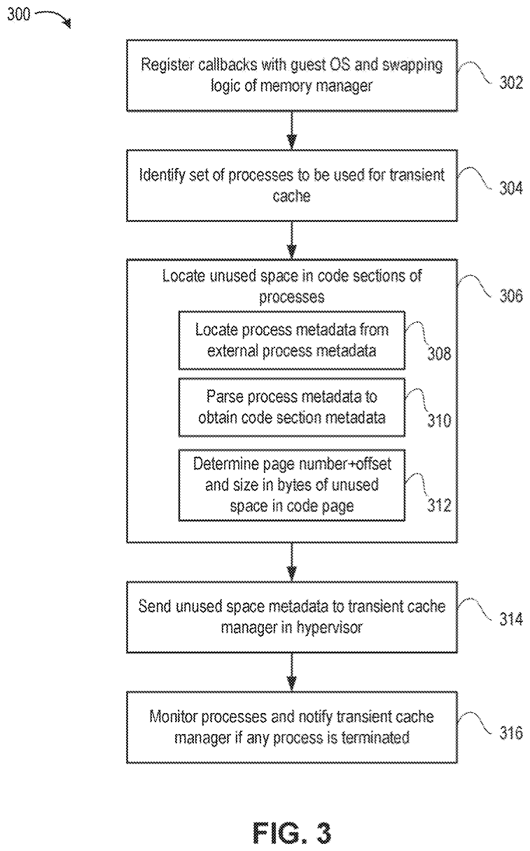

FIG. 3 is a flow diagram depicting a method 300 of identifying unused space in code pages for use as a transient cache according to embodiments. Method 300 begins at step 302, where transient cache driver 128 registers callbacks with guest OS 126 and swapping logic of memory manager 125. The callbacks are used to identify processes being executed and to be able to intercept swap-in and swap-out operations. At step 304, transient cache driver 128 identifies a set of processes to be used for finding unused space. Such processes are drivers, system services, and the like as discussed above.

At step 306, transient cache driver 128 locates unused space in code sections of the selected processes. Transient cache driver 128 can locate unused space 214 by first locating process metadata 204 (using external process metadata 202) and then code section metadata 206. Transient cache driver 128 reads code section metadata 206 to identify the last code page of the code section. Given the size of the executable code in code section metadata 206, transient cache driver 218 can determine a page number for code page 210 and a start address of unused space 214. Thus, at step 308, transient cache driver 128 locates process metadata 204 from external process metadata 202 for each selected process 127. At step 310, transient cache driver 128 parses process metadata 202 to obtain code section metadata 206 for each selected process 127. At step 312, transient cache driver 128 determines a page number of code page 210 and offset into code page 210 for unused space 214, as well as the size in bytes of unused space 214 (referred to as unused space metadata). Transient cache driver 128 performs steps 308, 310, and 312 for each selected process 127.

At step 314, transient cache driver 128 sends unused space metadata to transient cache manager 136 in hypervisor 118. At step 316, transient cache driver 128 monitors the selected processes for any terminated processes. In case of a terminated process for which unused space has been identified and in use by the transient cache, transient cache driver 128 sends a notification to transient cache manager 136 so that transient cache manager 136 can take appropriate action, discussed further below.

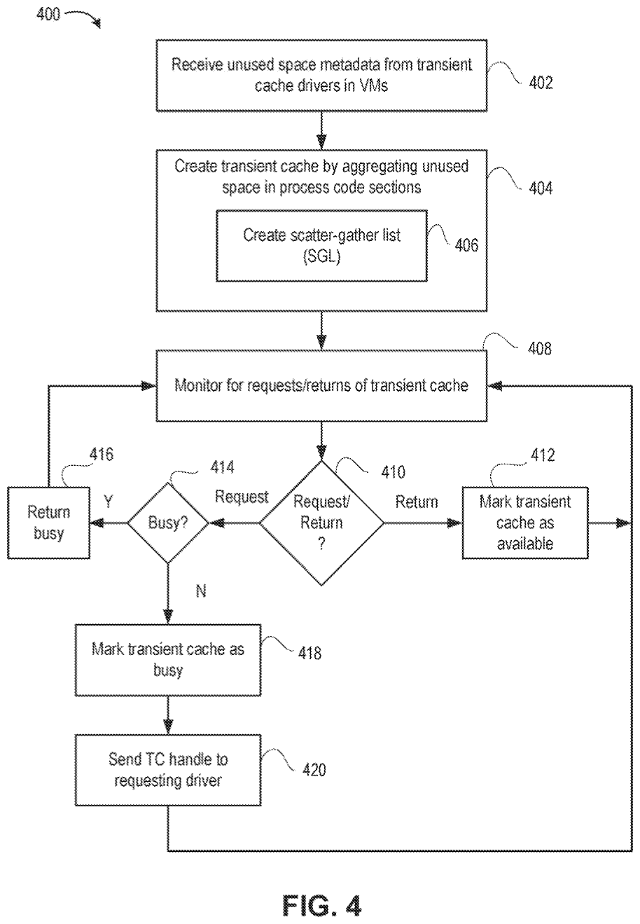

FIG. 4 is a flow diagram depicting a method 400 of creating and managing a transient cache in a hypervisor according to embodiments. Method 400 begins at step 402, where transient cache manager 136 receives unused space metadata from transient cache drivers 128 in VMs 120. Unused space metadata includes page numbers (within respective guest physical address spaces of VMs), offsets into such pages where unused space begins, and sizes in bytes of such unused spaces. For each VM 120, transient cache manager 136 can translate the received page numbers from guest physical address space to machine address space (e.g., using processor address translation instructions or calls to kernel 134 or VMMs 142).

At step 404, transient cache manager 136 creates TC 152 by aggregating unused space in process code sections as identified by unused space metadata received in step 402. Transient cache manager 136 creates TC metadata used to access TC 136. For example, at step 406, transient cache manager 136 can generate a scatter-gather list (SGL) of elements, each having address information and length of unused space that is part of TC 136. The address information can include a mapping of a guest physical page number to a machine page number and an offset into the page. The SGL effectively coalesces the disparate unused spaces into a block of memory in a linear address space.

At step 408, transient cache manager 136 monitors for requests and returns of TC 152. At step 410, transient cache manager 136 receives a request/return from a transient cache driver 128 in a VM 120. In case of a return, method 400 proceeds to step 412, where transient cache manager 136 marks TC 152 as available. In case of a request at step 410, method 400 proceeds to step 414. At step 414, transient cache manager 136 determines whether TC 152 is busy. TC 152 is busy if it is already in use by another VM 120. If TC 152 is busy, method 400 proceeds to step 416, where transient cache manager 136 returns a busy status to the requesting transient cache driver. If TC 152 is not busy, method 400 proceeds from step 414 to step 418.

At step 418, transient cache manager 136 marks TC 152 as busy. At step 420, transient cache manager 136 sends a TC handle to the requesting transient cache driver. The TC handle can be used to access the TC metadata describing TC 152. For example, the TC handle can be an address of the first element in the SGL, the total number of elements in the SGL, the total size of TC 152, and the like. Method 400 then returns to step 408, where transient cache manager 136 continues monitoring for requests/returns.

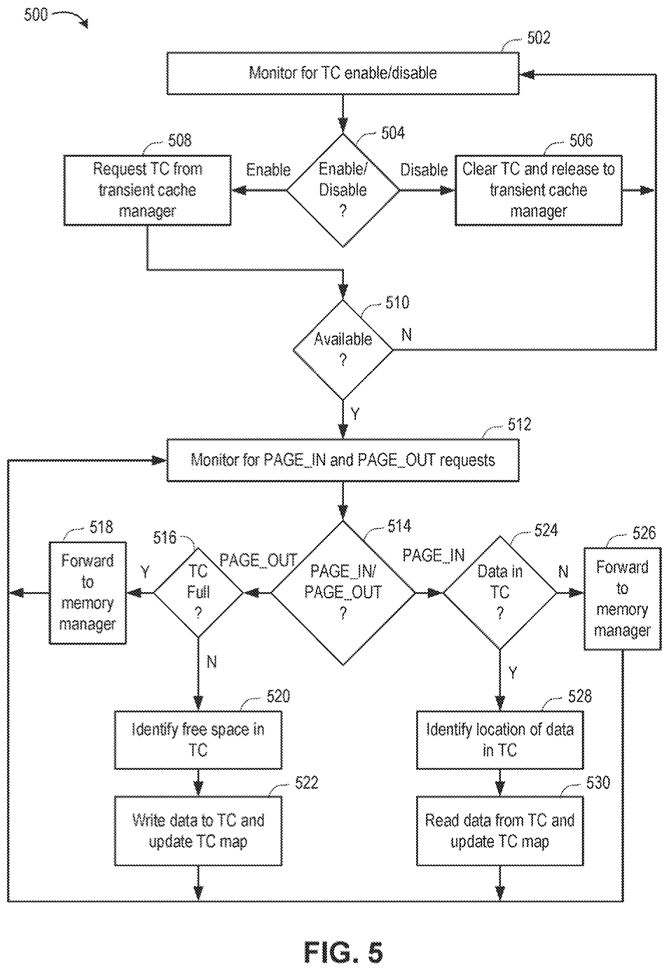

FIG. 5 is a flow diagram depicting a method 500 of using a transient cache in a virtual machine according to embodiments. Method 500 begins at step 502, where transient cache driver 128 monitors for enable or disabling of TC functionality. For example, a user can configure a critical VM to use TC 152. At step 504, transient cache driver 128 determines if TC functionality has been enabled/disabled. If disabled, transient cache driver 128 clears TC 152 and returns TC 152 to transient cache manager 136. Transient cache driver 128 is responsible for sanitizing TC 152 so that data stored therein during use does not persist after returning TC 152. If at step 504 TC functionality is being enabled, method 500 proceeds to step 508. At step 508, transient cache driver 128 requests TC 152 from transient cache manager 136. At step 510, transient cache driver 128 determines if TC 152 is available based on the response from transient cache manager 136, which can be either busy or a TC handle. If TC is busy and unavailable, method 500 returns to step 502. If transient cache driver 128 receives a TC handle and TC is available, method 500 proceeds to step 512.

At step 512, transient cache driver 128 monitors for PAGE_IN and PAGE_OUT operations. At step 514, transient cache driver 128 determines if there is a PAGE_IN/PAGE_OUT operation. For a PAGE_OUT operation, method 500 proceeds to step 516. At step 516, transient cache driver 128 determines if TC 152 is full or has insufficient space for the data. If so, method 500 proceeds to step 518, where transient cache driver 128 forwards the PAGE_OUT operation to memory manager 125. Memory manager 125 can then handle the operation normally. If at step 516 TC 152 is not full, method 500 proceeds to step 520. At step 520, transient cache driver 128 identifies free space in TC 152. For example, transient cache driver 128 can identify the next element in the SGL using a TC map or other metadata that tracks TC usage. At step 522, transient cache driver 128 writes the data to TC 152 and updates the TC map to track the data in TC 152. Method 500 returns to step 512.

If at step 514 transient cache driver 128 receives a PAGE_IN operation, method 500 proceeds to step 524. At step 524, transient cache driver 128 determines whether the requested data is in TC 152. For example, transient cache driver 128 can search the TC map to determine if the data (identified by an address being accessed) is in TC 152. If not, method 500 proceeds to step 526, where transient cache driver 128 forwards the PAGE_IN operation to memory manager 125. If the data is in TC 152, method 500 proceeds to step 528. At step 528, transient cache driver 128 identifies the location of the data in TC 152 (e.g., using a TC map or other metadata). At step 530, transient cache driver 128 reads the data from TC 152 and updates the TC map (or other tracking metadata). Method 500 then returns to step 512.

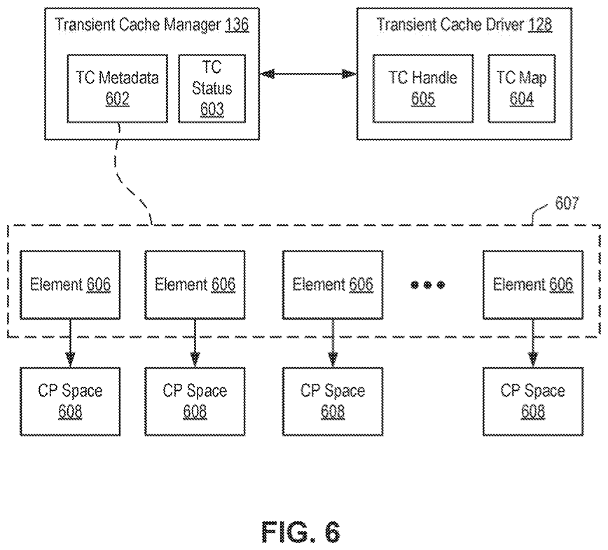

FIG. 6 is a block diagram depicting operation of transient cache manager 136 and transient cache driver 128 according to embodiments. Transient cache manager 136 maintains TC metadata 602 as described above. In an example TC metadata 602 is an SGL 607 having elements 606. Each element 606 points to unused space in a code page (“CP space 608”) and includes the available length of CP space 608. Upon request and if TC 152 is available, transient cache manager 136 provides TC handle 605 to transient cache driver 128. TC handle 605 can include any information for accessing TC metadata 602 (e.g., an address of SGL 607, a number of elements 606, a total size of TC 152, and the like). During reading/writing to TC 152, transient cache driver 128 can maintain metadata for tracking the data written or read, as well as how much room is left in TC 152 (“TC map 604”).

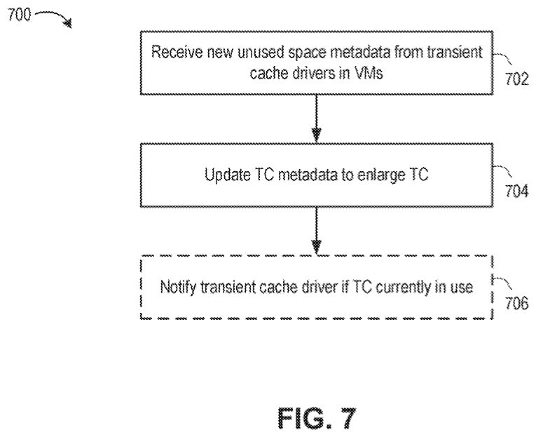

FIG. 7 is a flow diagram depicting a method 700 of updating a transient cache as new virtual machines become active in according to embodiments. Method 700 begins at step 702, where transient cache manager 136 receives new unused space metadata from transient cache drivers 128 in new VMs 120 that have become active. At step 704, transient cache manager 136 updates the TC metadata (e.g., SGL) to enlarge TC 152 with the new unused space. At step 706, transient cache manager 136 can notify a transient cache driver 128 that is currenting using TC 152 that TC 152 has been enlarged. Alternatively, in other embodiments, transient cache manager 136 can delay updating the TC metadata to enlarge TC 152 until TC 152 is free.

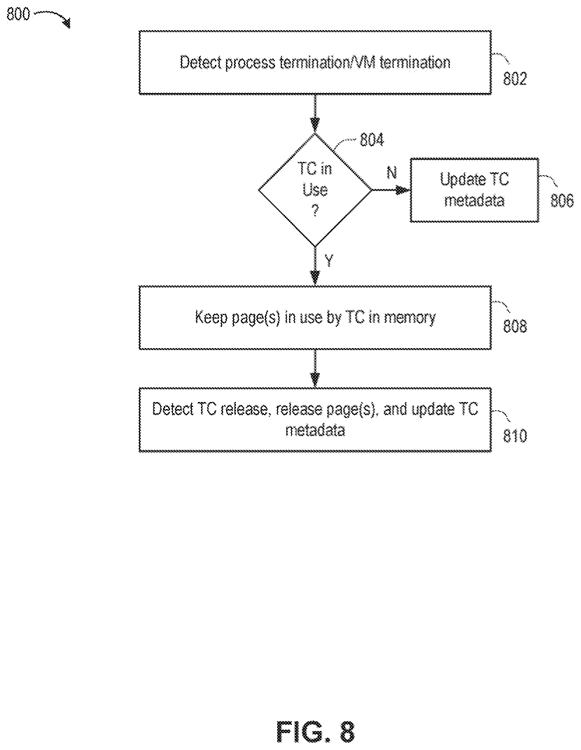

FIG. 8 is a flow diagram depicting a method 800 of updating a transient cache in case of process or VM termination according to embodiments. Method 800 begins at step 802, where transient cache manager 136 detects process termination/VM termination. For example, a transient cache driver 128 can notify transient cache manger 136 of process termination (e.g., step 316 in method 300). Transient cache manager 136 can monitor VM status and detect when a VM is terminated (or register callbacks with VMMs 142). At step 804, transient cache manager 136 determines if TC 152 is currently in use. If not, method 800 proceeds to step 806, where transient cache manager 136 updates the TC metadata to remove the unused space from the page(s) that are freed from the process termination/VM termination. If at step 804 TC 152 is in use, method 800 proceeds to step 808. At step 808, transient cache manager 136 instructs VMM 142 to keep page(s) in use by TC 152 in memory, rather than free such page(s) due to the detected termination. At step 810, transient cache manager 136 detects TC release by a transient driver 128, releases the relevant page(s) associated with the terminated process/VM, and updates the TC metadata.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method of providing a transient cache in system memory of a host for swap space on storage accessible by the host, the method comprising:
identifying, by transient cache drivers executing in virtual machines (VMs) supported by a hypervisor executing on the host, unused space in code pages of a plurality of processes executing in the VMs;
sending, from the transient cache drivers to a transient cache manager of the hypervisor, unused space metadata describing the unused space;
creating, by the transient cache manager based on the unused space metadata, the transient cache in the system memory by aggregating the unused space; and
providing, to a first transient cache driver of the transient cache drivers executing in a first VM of the VMs, information for accessing the transient cache.

2. The method of claim 1, further comprising:
receiving, by the first transient cache driver, a swap operation from a guest operating system (OS) in the first VM;
writing data to, or reading data from, the transient cache in response to the swap operation.

3. The method of claim 2, further comprising:
determining, by the first transient cache driver, that the transient cache has insufficient space or that requested data is not present in the transient cache and, in response, forwarding the swap operation to a memory manager of the guest OS.

4. The method of claim 1, wherein the step of identifying comprises:
identifying process metadata for the plurality of processes;
identifying code section metadata in the process metadata; and
identifying a location and size for each of a plurality of portion of the unused space in the respective plurality of code pages.

5. The method of claim 1, wherein the step of creating the transient cache comprises:
creating a scatter-gather list (SGL) having a plurality of elements, each of the plurality of elements including an address and a size of a portion of the unused space.

6. The method of claim 5, wherein the information provided from the transient cache manager to the first transient cache driver includes a handle to the SGL and a size of the transient cache.

7. The method of claim 1, wherein the first transient cache driver maintains metadata for tracking data stored in the transient cache.

8. A non-transitory computer readable medium having instructions stored thereon that when executed by a processor cause the processor to perform a method of providing a transient cache in system memory of a host for swap space on storage accessible by the host, the method comprising:
identifying, by transient cache drivers executing in virtual machines (VMs) supported by a hypervisor executing on the host, unused space in code pages of a plurality of processes executing in the VMs;
sending, from the transient cache drivers to a transient cache manager of the hypervisor, unused space metadata describing the unused space;
creating, by the transient cache manager based on the unused space metadata, the transient cache in the system memory by aggregating the unused space; and
providing, to a first transient cache driver of the transient cache drivers executing in a first VM of the VMs, information for accessing the transient cache.

9. The non-transitory computer readable medium of claim 8, further comprising:
receiving, by the first transient cache driver, a swap operation from a guest operating system (OS) in the first VM;
writing data to, or reading data from, the transient cache in response to the swap operation.

10. The non-transitory computer readable medium of claim 9, further comprising:
determining, by the first transient cache driver, that the transient cache has insufficient space or that requested data is not present in the transient cache and, in response, forwarding the swap operation to a memory manager of the guest OS.

11. The non-transitory computer readable medium of claim 8, wherein the step of identifying comprises:
identifying process metadata for the plurality of processes;
identifying code section metadata in the process metadata; and
identifying a location and size for each of a plurality of portion of the unused space in the respective plurality of code pages.

12. The non-transitory computer readable medium of claim 8, wherein the step of creating the transient cache comprises:
creating a scatter-gather list (SGL) having a plurality of elements, each of the plurality of elements including an address and a size of a portion of the unused space.

13. The non-transitory computer readable medium of claim 12, wherein the information provided from the transient cache manager to the first transient cache driver includes a handle to the SGL and a size of the transient cache.

14. The non-transitory computer readable medium of claim 8, wherein the first transient cache driver maintains metadata for tracking data stored in the transient cache.

15. A virtualized computing system, comprising:
a hardware platform comprising a processor and system memory and configured to access storage;
a software platform executing on the hardware platform and including a hypervisor supporting a plurality of virtual machines (VMs), the software platform configured to:
identify, by transient cache drivers executing in the VMs, unused space in code pages of a plurality of processes executing in the VMs;
send, from the transient cache drivers to a transient cache manager of the hypervisor, unused space metadata describing the unused space;
create, by the transient cache manager based on the unused space metadata, a transient cache in the system memory by aggregating the unused space; and
providing, to a first transient cache driver of the transient cache drivers executing in a first VM of the VMs, information for accessing the transient cache.

16. The virtualized computing system of claim 15, wherein the software platform is configured to:
receive, by the first transient cache driver, a swap operation from a guest operating system (OS) in the first VM;
write data to, or read data from, the transient cache in response to the swap operation.

17. The virtualized computing system of claim 16, wherein the software platform is configured to:
determine, by the first transient cache driver, that the transient cache has insufficient space or that requested data is not present in the transient cache and, in response, forward the swap operation to a memory manager of the guest OS.

18. The virtualized computing system of claim 15, wherein the software platform is configured to identifying the unused space by:
identifying process metadata for the plurality of processes;
identifying code section metadata in the process metadata; and
identifying a location and size for each of a plurality of portion of the unused space in the respective plurality of code pages.

19. The virtualized computing system of claim 15, wherein the software platform is configured to create the transient cache by:
creating a scatter-gather list (SGL) having a plurality of elements, each of the plurality of elements including an address and a size of a portion of the unused space.

20. The virtualized computing system of claim 15, wherein the first transient cache driver maintains metadata for tracking data stored in the transient cache.
